(19) United States
(12) Patent Application Publication
(10) Pub. No.: US 2012/0120007 A1
(43) Pub. Date: May 17, 2012

(54) TRANSPARENT DISPLAY APPARATUS AND METHOD OF CONTROLLING THE SAME

(75) Inventors: Sang-Moo Choi, Yongin-city (KR); Jin-Koo Chung, Yongin-city (KR)

(73) Assignee: Samsung Mobile Display Co., Ltd., Yongin-city (KR)

(21) Appl. No.: 13/209,337

(22) Filed: Aug. 12, 2011

(30) Foreign Application Priority Data
Nov. 16, 2010 (KR) 10-2010-0113906

(51) Int. Cl. G09G 5/10; G09G 3/30; G06F 3/041

(52) U.S. Cl. 345/173; 345/690; 345/76

(57) ABSTRACT

A method of controlling a transparent display apparatus and a transparent display apparatus are disclosed. According to one aspect, the method includes detecting a subject, defining a subject area corresponding to the subject, and displaying a single color image in the subject area.

### CROSS-REFERENCE TO RELATED APPLICATIONS

This application claims the benefit of Korean Patent Application No. 10-2010-0113906, filed on Nov. 16, 2010, in the Korean Intellectual Property Office, the disclosure of which is incorporated herein in its entirety by reference.

### BACKGROUND

1. Field

The disclosed technology relates to a transparent display apparatus and a method of controlling the same.

2. Description of the Related Technology

A transparent display is configured as a display in which an image is displayed and the opposite side of the display is also viewable from one side or both sides of the display. In general, it is difficult to realize a transparent display due to limitations related to the aperture ration of the pixels that form the display, i.e. the ration between the transmissive portion of the pixel and its surrounding electronics. Furthermore, difficulties in transparent thin film transistors and transparent wiring configurations also limit the production of a transparent display apparatus. However, as aperture ratios of displays are increased for higher luminance and transparent materials are developed, various attempts to realize a transparent display have been made by forming transparent thin film transistors and transparent wiring. In particular, various attempts to realize transparent displays which are useable in various applications have been made in the field of organic light emitting diode (OLED) displays.

### SUMMARY OF CERTAIN INVENTIVE ASPECTS

According to some aspects, a method of controlling a transparent display apparatus is disclosed. The method includes detecting a subject, defining a subject area corresponding to the subject, and displaying a single color image in the subject area.

According to some aspects, a transparent display apparatus including a transparent display unit for displaying an input image is disclosed. The transparent display apparatus includes a subject detector configured to generate a detection signal by detecting contact or proximity of a subject, a subject recognition unit configured to detect the subject according to the detection signal and defining a subject area corresponding to the subject, and a data processor configured to process the input image so as to display a single color image in the subject area.

### BRIEF DESCRIPTION OF THE DRAWINGS

The above and other features and advantages of the present invention will become more apparent by describing in detail exemplary embodiments thereof with reference to the attached drawings in which:

FIG. 1 illustrates a capturing method according to some embodiments;

FIGS. 2, 3A, 3B, and 3C illustrate capturing processes according to some embodiments;

FIG. 4 is a cross-sectional view of a transparent display panel according to some embodiments;

FIG. 5 is a block diagram of a transparent display unit according to some embodiments;

FIG. 6 is a flowchart illustrating a method of controlling a transparent display apparatus, according to some embodiments;

FIG. 7 is a flowchart illustrating a method of controlling a transparent display apparatus according to some embodiments;

FIG. 8 is a flowchart illustrating a method of detecting a subject according to some embodiments; and

FIG. 9 is a flowchart illustrating a method of detecting a subject according to some embodiments.

### DETAILED DESCRIPTION OF CERTAIN INVENTIVE EMBODIMENTS

Exemplary aspects will now be described more fully with reference to the accompanying drawings, in which exemplary embodiments are shown. In the description, a description of elements which are known to one of ordinary skill in the art may be omitted.

The specification and drawings are not provided to limit the scope of the present invention and the scope of the present invention may be defined by claims. The terms used herein may be construed as being appropriate for relaying the concept of the technical ideas that are disclosed.

Hereinafter, one or more embodiments will be described more fully with reference to the accompanying drawings.

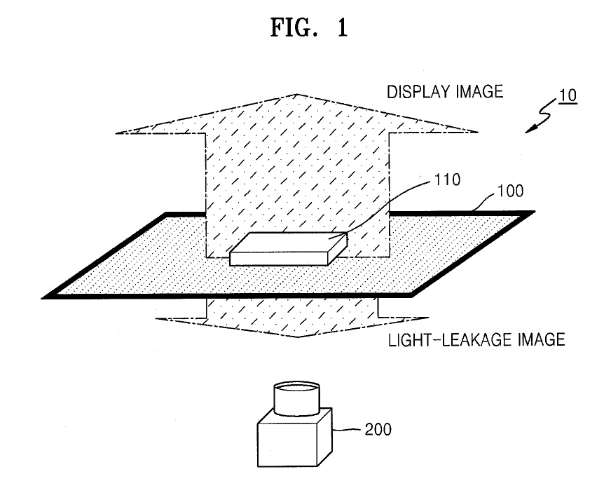

FIG. 1 illustrates a capturing method according to some embodiments.

In detail, FIG. 1 illustrates a transparent display apparatus 10 including a transparent display panel 100 and a capturing unit 200. The transparent display panel 100 displays an image on a front surface thereof and does not display an image on a rear surface thereof. Ideally, no image is displayed on the rear surface of the transparent display panel 100. Viewing the transparent display panel 100 from the rear surface thereof, the transparent display panel 100 may be transparent. However, in general, a light-leakage image occurs. Thus, viewing from the rear surface of the transparent display panel 100, a light-leakage image may exist as illustrated in FIG. 1.

As illustrated in FIG. 1, when a subject 110 disposed on the transparent display panel 100 is captured by the capturing unit 200 through the transparent display panel 100 in the transparent display apparatus 10, light incident from the light-leakage image and the subject 110 interfere with each other and the quality of a captured image may be reduced.

In order to prevent this, the transparent display panel 100 may not display an image at the moment the subject 110 is captured by the capturing unit 200. As a result, the display image and the light-leakage image are completely removed, and thus, interference of light incident from the light-leakage image and the subject 110 may be completely removed. However, the transparent display panel 100 may be turned off so that flickers may be generated in the transparent display panel 100 or the lifetime of the transparent display panel 100 may be reduced. Furthermore, it is difficult to match a point of time when the image is not displayed on the transparent display panel 100 with the capturing speed of the capturing unit 200.

As another method of preventing reduction in quality of the captured image due to the light-leakage image, a captured image may be retouched. In this case, an image input to the transparent display panel 100 may be used to remove a value corresponding to the light-leakage image from the capture image. However, the light-leakage image may not be completely removed by retouching, and thus, the quality of the captured image is still reduced.

According to some embodiments, the transparent display panel 100 displays an area corresponding to the subject 110 as a single color image. The single color image of the area corresponding to the subject 110 may have the same grayscale.

For example, the area corresponding to the subject 110 may have the same size and shape as the subject 110. As another example, although the area corresponding to the subject 110 has a different size and shape from the subject 110, when the subject 110 is captured by at least the capturing unit 200, the size and shape of the area corresponding to the subject 110 may be similar to that of the subject 110. As a result, the size and shape of the area corresponding to the subject 110 may be slightly larger than the subject 110 so that an area on which the subject 110 may be displayed in a single color.

According to some embodiments, when the subject 110 is captured by the capturing unit 200, noise due to the light-leakage image of the transparent display panel 100 may not be generated in the captured image of the area corresponding to the subject 110, and thus, the quality of an image captured through the transparent display panel 100 may be improved. Also, in the image captured through the transparent display panel 100, a single-colored light leakage image may only be mixed in the area corresponding to the subject 110, and thus, a light-leakage image component may be easily estimated. Thus, retouching is simplified and quality correction performance due to retouching may be improved.

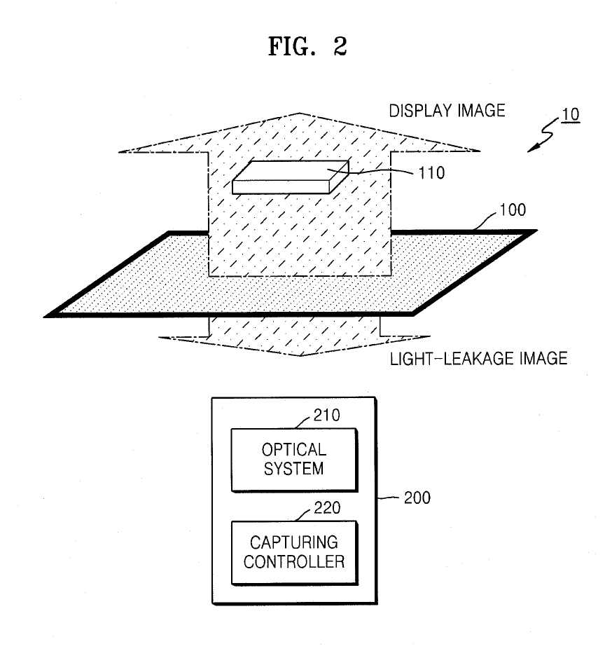

FIGS. 2, 3A, 3B, and 3C illustrate capturing processes according to some embodiments.

The transparent display apparatus 10 according to the some embodiments includes the transparent display panel 100 which displays an image on the front surface and does not display an image on the rear surface. However, a light-leakage image may exist on the rear surface of the transparent display panel 100. Also, the transparent display apparatus 10 may be configured so as not to include the capturing unit 200. Rather, the transparent display apparatus 10 may be configured to communicate a signal with the capturing unit 200. Alternatively, the transparent display apparatus 10 may also include the capturing unit 200.

The capturing unit 200 is disposed to capture the subject 110 disposed at the front of the transparent display panel 100 from the rear surface of the transparent display panel 100. A capturing area of the capturing unit 200 may be the entire area of the transparent display panel 100. As another example, a capturing area of the capturing unit 200 may be fixed to a certain area of the transparent display panel 100. A zooming function of the capturing unit 200 may be used to adjust the capturing area.

The capturing unit 200 may include an optical system 210 and a capturing controller 220. The optical system 210 may include a lens, an iris, and a light-receiving surface imaging device. The optical system 210 forms an image on a light-receiving surface of the imaging device by using light incident in a rear surface direction from the front surface of the transparent display panel 100 and converts the incident light into an electric image signal. The capturing controller 220 provides a control signal to the optical system 210 and controls a capturing process. The capturing controller 220 may receive a shutter-release signal, provide the received shutter-release signal to the optical system 210, and control the optical system 210 to capture an image. Also, the capturing controller 220 may receive an image signal generated by the imaging device of the optical system 210 and provide the received image signal to a predetermined data processor of the transparent display apparatus 10.

As illustrated in FIG. 2, in the transparent display panel 100 according to some embodiments, when the subject 110 is far from the transparent display panel 100, an input image is displayed in all areas of the transparent display panel 100. Here, a light-leakage image, which may be generated by the rear surface of the transparent display panel 100, is generated in all areas of the transparent display panel 100.

Then, as illustrated in FIG. 3A, when the subject 110 is disposed at the front of the transparent display panel 100, the transparent display panel 100 detects the subject 110 and a subject area SA corresponding to the subject 110. As a result, the subject area SA is displayed as a single color image, as illustrated in FIG. 3B. The case where the subject 110 is disposed at the front of the transparent display panel 100 includes the case where the subject 110 contacts the transparent display panel 100 and the case where the subject 110 is close to the front of the transparent display panel 100 by a predetermined interval. When the subject 110 contacts or is close to the transparent display panel 100, the subject 110 is detected and the subject area SA is defined as described in detail below.

According to some embodiments, the single color image is an image having the same grayscale in the subject area SA and may be defined in various ways.

According to some embodiments, the single color image may be a black image. A black image is an image in which a grayscale of sub-pixels of all color components (for example, red, green, and blue sub-pixels) is 0. Thus, brightness of a display image of the subject area SA and the light-leakage image is 0 and the transparent display panel 100 does not emit light in the subject area SA. Accordingly, when the subject 110 is captured, interference between the light incident from the subject 110 and the light-leakage image is not generated. As a result, the quality of an image in the subject area SA captured through the transparent display panel 100 is improved.

According to some embodiments, the single color image may be a white image. A white image is an image in which a grayscale of sub-pixels of all color components (for example, red, green, and blue sub-pixels) is a maximum. Thus, a display image of the subject area SA and the light-leakage image are colorless and have a brightness corresponding to the maximum grayscale. The capturing unit 200 performs capturing by receiving light incident from the subject 110. Since an amount of light is not sufficient in a surface of the subject 110 facing the capturing unit 200, quality of a captured image may be reduced. Accordingly, the white image is displayed on the subject area SA. As a result, light is provided to the surface of the subject 110 facing the capturing unit 200, as illustrated in FIG. 3C, so that the quality of the image capturing the subject 110 is improved.

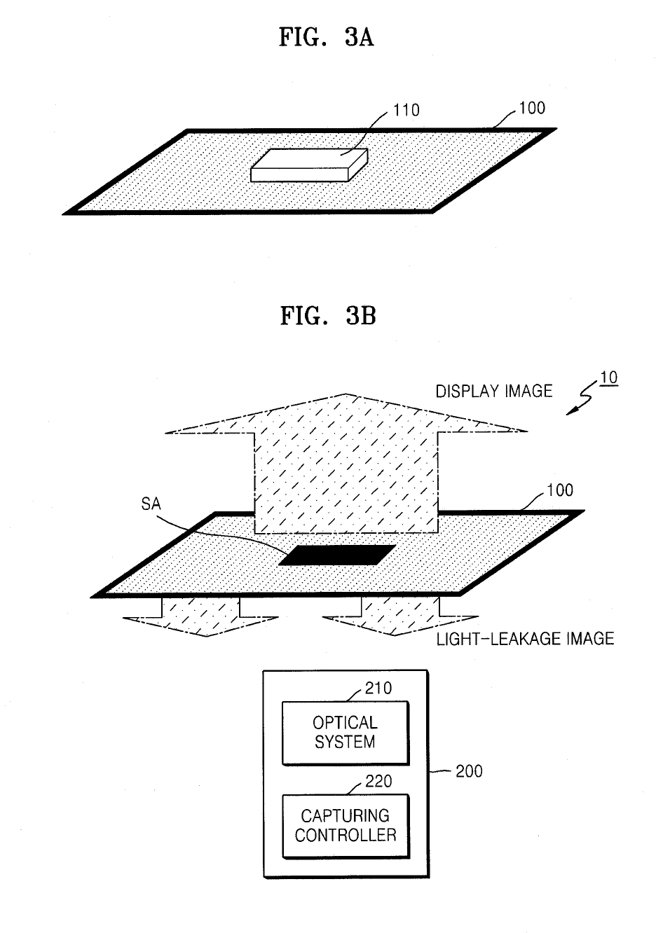

FIG. 4 is a cross-sectional view of the transparent display panel 100 according to some embodiments.

The transparent display panel 100 may include a transparent display unit 410 and a subject detector 420. As illustrated in FIG. 4, the transparent display unit 410 and the subject detector 420 may have a layer structure and may be disposed such that they overlap each other.

The transparent display unit 410 is a display panel including a plurality of pixels. The transparent display unit 410 may be an organic light emitting display panel including a plurality of pixels. In this instance, each pixel includes an organic light-emitting diode (OLED). Also, the transparent display unit 410 may be realized as a display panel in which a plurality of pixels and driving/control circuits, such as a gate driving unit and a data driving unit, are realized on a substrate. As another example, the transparent display unit 410 may be formed such that a plurality of pixels are realized on a substrate and driving/control circuits such as a gate driving unit and a data driving unit are formed as an integrated circuit chip. The integrated circuit chip may be installed on the substrate or may be electrically connected to the plurality of pixels using conducting tape, or the like.

The subject detector 420 detects whether the subject 110 contacts or is close to the transparent display panel 100. For example, the subject detector 420 may be a contact sensor for sensing the contact of the subject 110. The contact sensor may be an electrostatic touch screen, a decompressed touch screen, a decompressed sensor, or the like.

As another example, the subject detector 420 may be a proximity sensor for sensing an approach of the subject 110. The proximity sensor may be an optical sensor, an IR sensor, or the like.

As another example, the subject detector 420 may be configured to use the imaging device illustrated in the optical system 210 of FIG. 2 of the capturing unit 200 of FIG. 2 instead of the layer structure shown in FIG. 4. With a non-layered imaging device, the subject 110 is detected from an imaging signal generated by the imaging device.

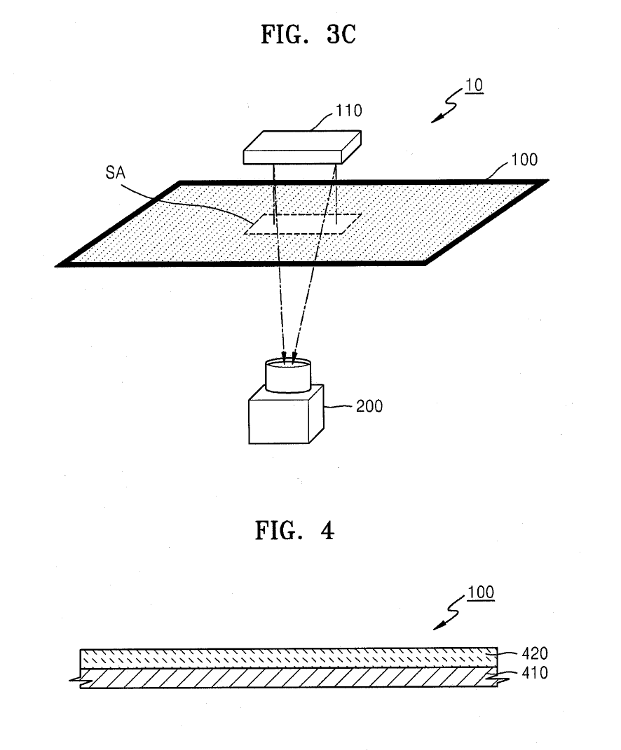

FIG. 5 is a block diagram of the transparent display unit 410 according to some embodiments.

The transparent display unit 410 includes a timing controller 510, a scan driver 520, a data driver 530, a pixel unit 540, a subject recognition unit 550, and a data processor 560.

The timing controller 510 receives an input image signal, a vertical synchronization signal, a horizontal synchronization signal, and a clock signal and generates a scan driving control signal and a data driving control signal.

The scan driver 520 generates scan signals having scan pulses sequentially applied in a column direction according to the scan driving control signal and outputs the scan signals to each pixel PX through scan lines S1 through Sn.

The data driver 530 generates data signals according to the input image based on the data driving control signal provided from the timing controller 510 and outputs the data signals to each pixel PX through data lines D1 through Dm. According to some embodiments, the data driver 530 may generate the data signals by using display data processed in the data processor 560 and input to the data driver 530.

The pixel unit 540 includes pixels PX disposed at cross-sections of the scan lines S1 through Sn and the data lines D1 through Dm. As illustrated in FIG. 5, each pixel PX may be arranged within an m*n matrix. Each pixel PX includes a light-emitting device, a high source voltage ELVDD, and a low source voltage ELVSS. The high source voltage ELVDD, and the low source voltage ELVSS allow the light-emitting devices to emit light, and are supplied to each pixel PX from the outside. Also, each pixel PX supplies a driving current or voltage to the light-emitting device, and the light-emitting device emits light having a brightness corresponding to the data signals. The light-emitting device may be an OLED.

Each pixel PX controls a current amount supplied to the light-emitting device, such as an OLED, in response to the data signals transmitted through the data lines D1 through Dm. Also, the OLED emits light having brightness corresponding to the data signal according to light-emitting control signals transmitted through light-emitting control lines E1 through En.

The subject recognition unit 550 detects the subject 110 by using a detection signal provided from the subject detector 420 and determines the subject area SA.

When the subject detector 420 is configured as a contact sensor, the subject recognition unit 550 determines that the subject 110 exists, when a detection signal sensing contact from the subject detector 420 is transmitted. As a result, the subject 110 is detected. Furthermore, the subject recognition unit 550 determines the area where the contact is sensed as the subject area SA.

When the subject detector 420 is configured as a proximity sensor, the subject recognition unit 550 may determine whether an object in close proximity exists by using the detection signal of the subject detector 420. The subject detector 420 may define the area where the object in close proximity exists as the subject area SA. Determining that the object in close proximity to a certain degree as the subject 110 may be previously determined or may be determined by a user. A threshold value used to detect the subject 110 may be adjusted by using the detection signal so as to adjust whether to determine that the object in close proximity to some degree as the subject 110.

When the subject detector 420 is realized as the imaging device of the capturing unit 200 of FIG. 2, the subject detector 420 may detect the subject 110 from the imaging signal. For example, when the focused subject 110 is detected within a predetermined focal length and when the subject 110 having a predetermined pattern is detected, the subject detector 420 determines that the subject 110 is detected, and thus, may define the subject area SA.

The data processor 560 generates display data provided to the data driver 530 by using the input image, and outputs the generated display data to the driver 530. The input image may be input from the timing controller 510 or a main device. The data processor 560 generates the input image as the display data by using the subject detection signal input from the subject recognition unit 550 and subject area information. Additionally or alternatively, the data processor 560 processes a portion of the input image corresponding to the subject area SA into a single color image, thereby generating the display data. More specifically, when the subject 110 is not detected by the subject recognition unit 550, the data processor 560 outputs the input image as the display data. When the subject 110 is detected by the subject recognition unit 550 and the subject area information is input, the data processor 560 converts a portion of the input image corresponding to the subject area SA into a single color image and generates the display data. As described above, the single color image may be a black image, white image, and the like.

In the previous description, the data driver 530 receives the display data through the data processor 560; however, the operation of the data driver 530 is not limited thereto. For example, when the data driver 530 receives the subject detection signal from the subject recognition unit 550 and the subject 110 is detected, the data driver 530 can receive the display data from the data processor 560. When the subject 110 is not detected, the data driver 530 can receive the display data from the timing controller 510.

When capturing of the image is completed, the data processor 560 may further display an input image on the subject area SA. Whether capturing of the image is completed may be known by the shutter-release signal input from the capturing controller 220 of FIG. 2. As another example, when the subject recognition unit 550 determines that the subject 110 does not exist, the data processor 560 may determine that capturing of the image is completed.

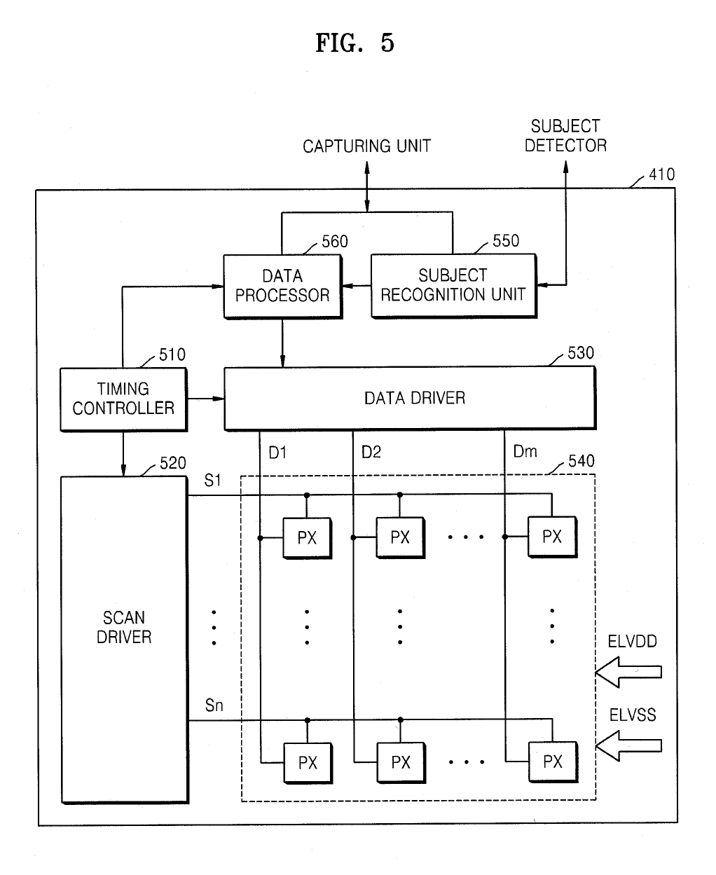

FIG. 6 is a flowchart illustrating a method of controlling the transparent display apparatus 10, according to some embodiments.

According to some embodiments, when an object that contacts to the transparent display panel 100 or an object that is close to the transparent display panel 100 is detected, the object is determined as the subject 110 and a capturing process is performed.

In the method of controlling the transparent display apparatus 10, when an object that contacts to the transparent display panel 100 or an object that is close to the transparent display panel 100 is detected, and thus, it is determined that the subject 110 exists, in operation S602, the subject area SA is determined from the detection signal, as illustrated by block S604. Then, in the method of controlling the transparent display apparatus 10, a single color image is displayed by being inserted to a portion corresponding to the subject area SA, as illustrated by block S606. When the single color image is displayed on the subject area SA, a capturing process is performed, as illustrated by block S608. When the capturing process is complete, as illustrated by block S610, an input image is displayed again on the subject area SA, as illustrated by block S612. Whether the capturing process is complete may be determined when the shutter-release signal is input or when the subject 110 is not detected.

Alternatively, if the subject 110 is not detected as determined in decision block S602, the input image is displayed, as illustrated by block S614.

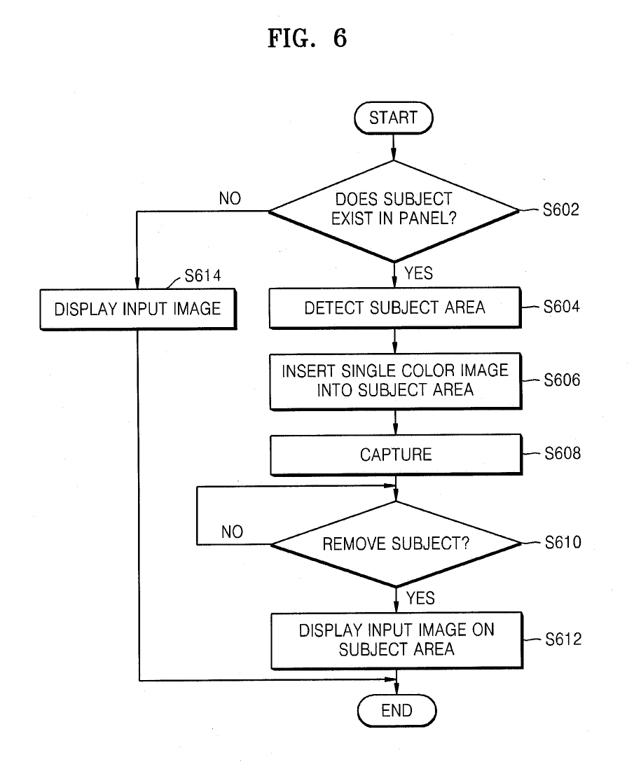

FIG. 7 is a flowchart illustrating a method of controlling transparent display apparatus 10, according to some embodiments. According to the some embodiments, when the shutter-release signal is input, the subject 110 is detected and the subject area SA is displayed with a single color image. In some embodiments, an error of determining an object that is not the subject 110 as the subject 110 may be prevented.

When the shutter-release signal is input, as illustrated by decision block S702, the subject 110 is detected and the subject area SA is detected, as illustrated by block S704. Alternatively, the method continues the monitor for a shutter release signal at decision block S702. When the subject 110 is detected and the subject area SA is defined, a single color image is displayed by being inserted into the portion corresponding to the subject area SA, as illustrated by block S706. A capturing process is performed, as illustrated in block S708. When the capturing process is completed, an input image is displayed again in the subject area SA, as illustrated in block S710.

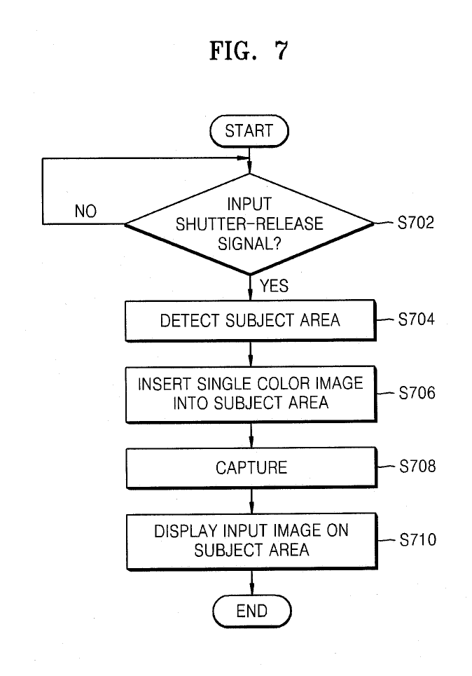

FIG. 8 is a flowchart illustrating a method of detecting the subject 110, according to some embodiments.

According to some embodiments, when the subject 110 is determined, whether a close object is the subject 110 may be unclear. According to some embodiments, when a close object is detected, as illustrated by block S802, the object is recognized as the subject 110, as illustrated by block S806, only when the object does not move for a certain period of time, as illustrated by decision block S804. If no movement occurs for a certain period of time, the subject area SA may be detected, as illustrated by block S808.

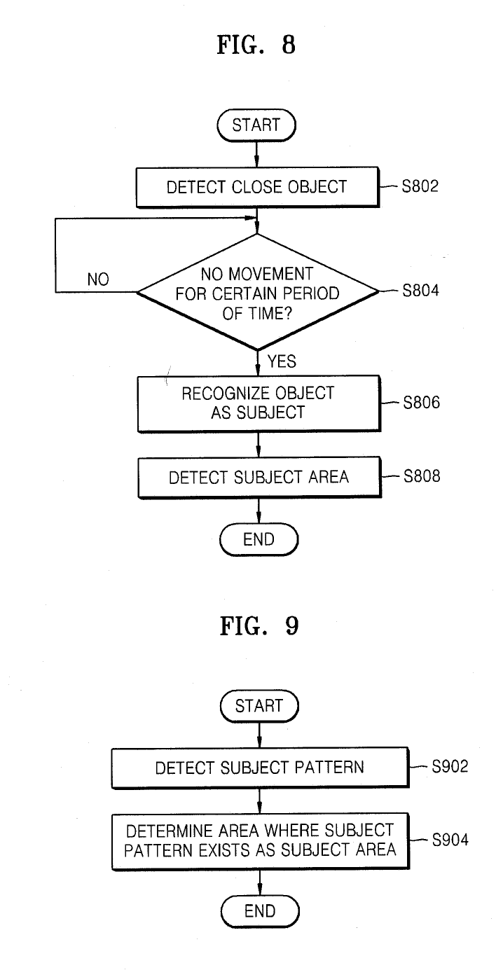

FIG. 9 is a flowchart illustrating a method of detecting the subject 110, according to some embodiments.

According to some embodiments discussed above, the capturing unit 200 of FIG. 2 captures the subject 110 having a predetermined pattern. For example, the capturing unit 200 of FIG. 2 captures the subject 110 having a regular pattern, such as barcodes, QR codes, faces, and the like. According to some embodiments, the subject detector 420 of FIG. 5 is realized as the imaging device of the capturing unit 200 of FIG. 2. In the method of detecting the subject 110 according to the some embodiments, when a predetermined pattern is detected from an imaging signal, as illustrated by block S902, it is determined that the subject 110 is detected and an area where a subject pattern exists is determined as the subject area SA, as illustrated by block S904.

According to the embodiments, when the subject is captured through the transparent display apparatus, interference due to the light-leakage image is removed so that the quality of the captured image is improved and the captured image may be easily retouched.

In addition, when the subject is captured through the transparent display apparatus, sufficient light is provided to the subject, and thus, the quality of the captured image may be improved.

According to some embodiments, a transparent display apparatus which may prevent a reduction in quality of a captured image due to an interference of light incident from a light-leakage image and a subject when the subject is captured through the transparent display apparatus is disclosed.

According to some embodiments, a transparent display apparatus having improved capturing quality by providing light to a subject when the subject is captured through the transparent display apparatus is disclosed.

According to some embodiments, a method of controlling a transparent display apparatus is disclosed. The method includes detecting a subject, defining a subject area corresponding to the subject, and displaying a single color image in the subject area. The method may further include capturing the subject through the transparent display panel.

The single color image may be a black image, or a white image or a black image. The method may further include detecting the subject by using a contact sensor included in the transparent display panel, and defining an area where a contact is sensed by the contact sensor as the subject area.

The method may further include detecting the subject by using a decompressed sensor included in the transparent display panel, and defining an area where pressure is sensed by the decompressed sensor as the subject area.

The method may further include capturing the subject when the single color image is displayed on the subject area, and displaying an input image on the subject area when the capturing is completed.

The detecting of the subject may be performed when a shutter-release signal is input.

The detecting of the subject may include detecting an object that is close to the front of the transparent display panel by using a proximity sensor, and determining the object as the subject when the object does not move for a certain time.

The detecting of the subject may include detecting a predetermined subject pattern from an imaging signal and the defining of the subject area includes defining an area corresponding to the subject pattern as the subject area.

The transparent display panel may be an organic light-emitting display panel. The transparent display apparatus may include a capturing unit for capturing the subject through the transparent display panel.

The single color image may be a black image, or a white image.

The subject detector is a contact sensor for sensing a contact of the subject and the subject recognition unit may define an area where the contact is sensed by using the contact sensor as the subject area.

The subject detector may be a pressure sensor and the subject recognition unit may define an area where pressure is sensed by the decompressed sensor as the subject area.

According to some embodiments, a transparent display apparatus including a transparent display unit for displaying an input image is disclosed. The transparent display apparatus includes a subject detector configured to generate a detection signal by detecting contact or proximity of a subject, a subject recognition unit configured to detect the subject according to the detection signal and defining a subject area corresponding to the subject, and a data processor configured to process the input image so as to display a single color image in the subject area.

The transparent display apparatus may further include a capturing unit configured to capture the subject when the single color image is displayed on the subject area and the data processor displays the input image in the subject area when the capturing is completed.

The subject recognition unit may detect the subject, when a shutter-release signal is input, and defines the subject area.

The subject detector may be a proximity sensor for detecting an object that is close to the front of the transparent display apparatus and the subject recognition unit may determine the object as the subject when the object does not move for a certain time.

The transparent display apparatus may further include a capturing unit configured to capture the subject through the transparent display unit, and the subject recognition unit detects a predetermined subject pattern from an imaging signal output from the capturing unit and defines an area corresponding to the subject pattern as the subject area.

The transparent display unit may be an organic light-emitting display panel.

While the present invention has been particularly shown and described with reference to exemplary embodiments thereof, it will be understood by those of ordinary skill in the art that various changes in form and details may be made therein without departing from the spirit and scope of the present invention as defined by the following claims.

What is claimed is:

1. A method of controlling a transparent display apparatus, the method comprising:
detecting a subject;
defining a subject area corresponding to the subject; and
displaying a single color image in the subject area.

2. The method of claim 1, further comprising capturing the subject through the transparent display panel.

3. The method of claim 1, wherein the single color image is a black image.

4. The method of claim 1, wherein the single color image is a white image.

5. The method of claim 1, further comprising:
detecting the subject with a contact sensor, wherein the contact sensor is included in the transparent display panel; and
defining an area where a contact is sensed by the contact sensor as the subject area.

6. The method of claim 1, further comprising:
detecting the subject by using a decompressed sensor included in the transparent display panel; and
defining an area where pressure is sensed by the decompressed sensor as the subject area.

7. The method of claim 1, further comprising:
capturing the subject when the single color image is displayed on the subject area; and
displaying an input image on the subject area when capturing the subject is completed.

8. The method of claim 1, wherein detecting the subject is performed when a shutter-release signal is input.

9. The method of claim 8, wherein the detecting of the subject comprises:
detecting an object that is close to the front of the transparent display panel by using a proximity sensor; and
determining the object as the subject when the object does not move for a period of time.

10. The method of claim 1, wherein detecting the subject comprises detecting a predetermined subject pattern from an imaging signal, and defining the subject area comprises defining an area corresponding to the subject pattern as the subject area.

11. The method of claim 1, wherein the transparent display panel is an organic light-emitting display panel.

12. A transparent display comprising:
a transparent display unit configured to display an input image;
a subject detector configured to generate a detection signal by detecting contact or proximity of a subject;
a subject recognition unit configured to detect the subject according to the detection signal and define a subject area corresponding to the subject; and
a data processor configured to process the input image so as to display a single color image in the subject area.

13. The transparent display apparatus of claim 12, further comprising a capturing unit configured to capture the subject through the transparent display panel.

14. The transparent display apparatus of claim 12, wherein the single color image is a black image.

15. The transparent display apparatus of claim 12, wherein the single color image is a white image.

16. The transparent display apparatus of claim 12, wherein the subject detector is a contact sensor configured to sense a contact of the subject, and wherein the subject recognition unit is configured to define an area where the contact is sensed by using the contact sensor as the subject area.

17. The transparent display apparatus of claim 12, wherein the subject detector is a pressure sensor, and wherein the subject recognition unit is configured to define an area where pressure is sensed by the decompressed sensor as the subject area.

18. The transparent display apparatus of claim 12, wherein the transparent display apparatus further comprises a capturing unit configured to capture the subject when the single color image is displayed on the subject area and the data processor displays the input image in the subject area when the capturing is completed.

19. The transparent display apparatus of claim 12, wherein the subject recognition unit is configured to detect the subject, when a shutter-release signal is input, and defines the subject area.

20. The transparent display apparatus of claim 19, wherein the subject detector is a proximity sensor for detecting an object that is close to the front of the transparent display apparatus and the subject recognition unit determines the object as the subject when the object does not move for a period of time.

21. The transparent display apparatus of claim 12, further comprising a capturing unit configured to capture the subject through the transparent display unit, and wherein the subject recognition unit is configured to detect a predetermined subject pattern from an imaging signal output from the capturing unit and define an area corresponding to the subject pattern as the subject area.

22. The transparent display apparatus of claim 12, wherein the transparent display unit is an organic light-emitting display panel.
